(19) United States
(12) Patent Application Publication
(10) Pub. No.: US 2007/0074922 A1
(43) Pub. Date: Apr. 5, 2007

(54) Vehicle interface based on a shift of the torso of a user

(76) Inventors: Joshua D. Coombs, Haslett, MI (US); Jeffrey Schox, San Francisco, CA (US)

Correspondence Address: SCHOX PLC, 209 N. MAIN STREET #200, ANN ARBOR, MI, 48104, US

(21) Appl. No.: 11/239,804

(22) Filed: Sep. 30, 2005

(51) Int. Cl. B60K 26/00

(52) U.S. Cl. 180/315

(57) ABSTRACT

One of the embodiments of the invention includes an interface for communicating a vehicle command from a user to a vehicle. The interface preferably includes an engagement system to engage the torso of a user, a sensor system to sense forces imparted by the torso of the user, and a processor to interpret a vehicle command based on a shift of the torso of the user and to communicate the vehicle command to a vehicle.

### CROSS-REFERENCE TO RELATED APPLICATIONS

This application is related to application Ser. No. ______ entitled “Vehicle Interface Based On The Weight Distribution Of A User” (docketed JOSH-Po1), application Ser. No. ______ entitled “Vehicle Interface Based On A Shift Of The Appendages Of A User” (docketed JOSH-Po3), and application Ser. No. ______ entitled “Vehicle Interface To Communicate A Safety Alert Mode Command” (docketed JOSH-Po4), which were all filed on 30 Sep. 2005 and are all incorporated in their entirety by this reference.

### BRIEF DESCRIPTION OF THE FIGURES

FIGS. 1-3 include side and front views of the first preferred embodiment.

FIGS. 4-6 include side and front views of the second preferred embodiment.

FIGS. 7-9 include side and front views of the third preferred embodiment.

FIG. 10 includes side views of the fourth preferred embodiment.

FIG. 11 includes isometric views of the second variation of the engagement system, showing the seat bolsters in an “engaged” mode and a “relaxed” mode.

### DESCRIPTION OF THE PREFERRED EMBODIMENTS

The following description of four preferred embodiments of the invention is not intended to limit the invention to these preferred embodiments, but rather to enable any person skilled in the art to make and use this invention.

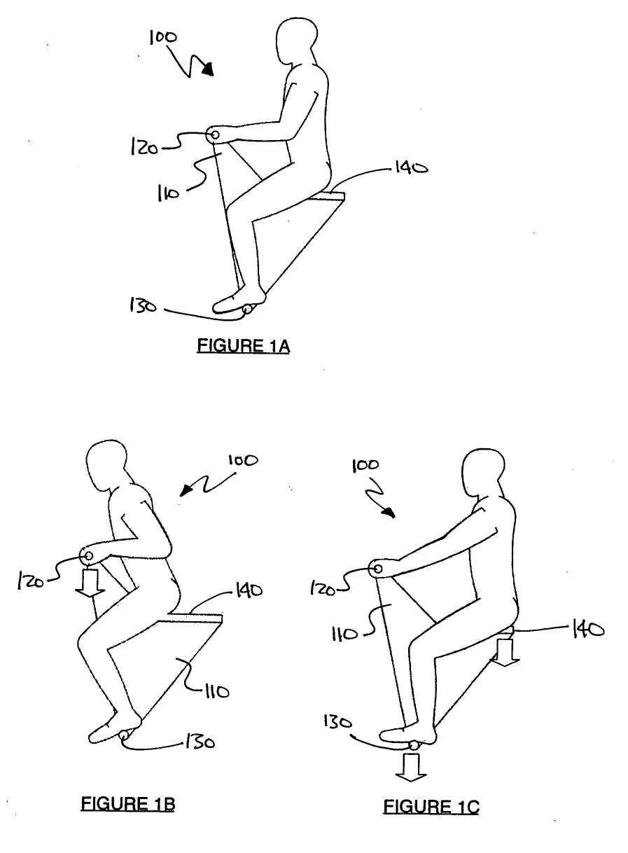

As shown in the FIGS. 1-10, the interface 100 of the preferred embodiments includes an engagement system 110, a sensor system coupled to the engagement system 110, and a processor adapted to interpret a vehicle command based on an output from the sensor system and to communicate the vehicle command to a vehicle. While most of the commands are known in the art, the invention teaches a more intuitive interface to sense and interpret these commands. The invention, therefore, provides an interface 100 that senses and interprets new commands (such as a vehicle roll or pitch command in an automobile) that the user would not have been able to quickly activate with conventional interfaces, or more commands (such as a vehicle configuration command in an aircraft) that the user would not have been able to easily navigate with conventional interfaces. With this interface 100, the vehicle may be able to react better or faster to upcoming situations (such as a bump, a turn, or a climb), since the user may be able to communicate better or faster information to the vehicle. With this interface 100, the vehicle may also be able to perform better and/or the user may be able to perform with less mental or physical strain. The vehicle, it is hoped, will become a more natural (or intuitive) extension of the user with the incorporation of this invention.

The interface 100 of the preferred embodiments is preferably integrated into a vehicle. The vehicle is preferably a wheeled vehicle (such a two-wheeled bicycle or motorcycle, a three-wheeled cycle, a four-wheeled automobile, truck, or all-terrain vehicle, or a multi-wheeled tractor), a watercraft (such as a jet ski, a motorboat, or a submarine), an aircraft (such as a small plane, a helicopter, or a hovercraft), a tracked vehicle (such as a snowmobile or a tank), or a railed vehicle (such as a train). The vehicle may, however, be any suitable vehicle that transports people or cargo with either human power, fuel power, or any other suitable power source. Although the interface 100 is preferably integrated into a vehicle, the interface 100 may alternatively be remotely coupled to a vehicle or may alternatively be integrated into a virtual vehicle environment. Alternatively, the interface 100 may be integrated into any suitable environment.

The command communicated by the interface 100 of the preferred embodiment is preferably a vehicle command. The vehicle command is preferably an attitude command (such as a vehicle pitch or a vehicle roll), a handling command (such as a suspension command or a height command), a configuration command (such as a track command, a wheelbase command, a hull shape command, or a wing shape command), a mode command (such as a “safety alert mode” command), or a combination command (such as a “bunny hop” command). The command communicated by the interface 100 may, however, be any suitable command. Although the command is preferably communicated to a vehicle, the command may be communicated to any suitable device or system.

### 1. The Engagement System of the Preferred Embodiments

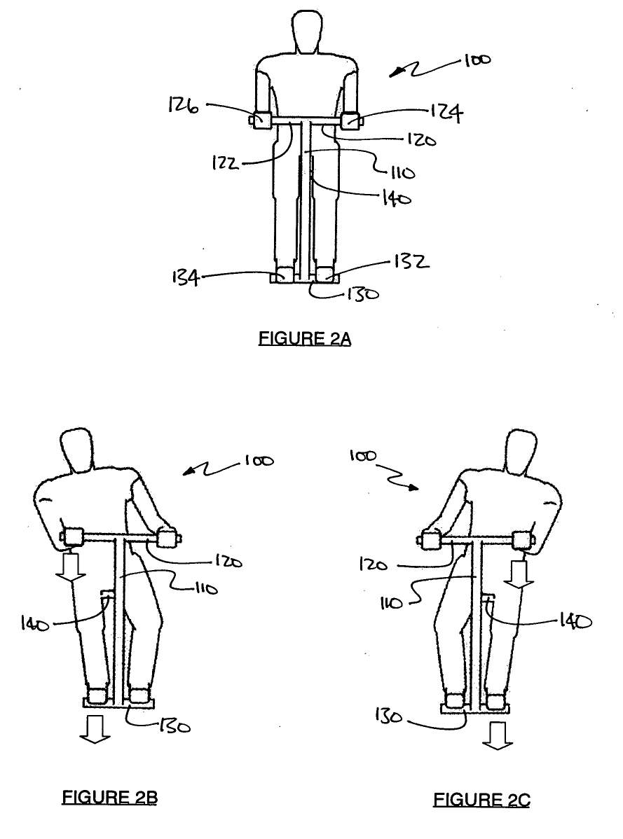

The engagement system 110 of the preferred embodiments functions to engage or support the user in the vehicle. In a first variation, as shown in FIGS. 1-3, the engagement system 110 supports at least a portion of the weight of the user, engages at least two appendages of the user, and includes: at least two of the following: a handbase 120, a footbase 130, and a seat 140. As best shown in FIG. 2A, the handbase 120 preferably includes a handlebar 122 with a left handgrip 124 engageable by the left hand of the user and a right handgrip 126 engageable by the right hand of the user. The footbase 130 preferably includes a left footrest 132 engageable by the left foot of the user and a right footrest 134 engageable by the right foot of the user. The handbase 120 and footbase 130 may alternatively include any suitable device or system to engage the hands and feet of the user. As best shown in FIG. 1A, the seat 140 preferably includes a straddle-type seat 140 (most commonly found on cycles and all-terrain vehicles) engageable by the lower torso of the user, but may alternatively include any suitable device to engage the lower torso of the user.

In a second variation, as shown in FIGS. 4-6 and 11, the engagement system 100 engages the torso of the user and includes at least two of the following: a seat back 142, a seat bottom 144, and side bolsters 146 and 148. The seat back 142 and the seat bottom 144 are preferably conventional seating elements, but may alternatively be any suitable system that engages the torso of the user, including a platform that supports the user in a prone position. The side bolsters 146 and 148 preferably include a left side bolster 146 engageable with the left side of the torso of the user and a right side bolster 148 engageable with a right side of the torso of the user. Preferably, the side bolsters 146 and 148 have an “engaged” position (FIG. 11A) in which they engage the torso of the user and a “relaxed” mode (FIG. 11B) in which they do not engage the torso user. The “engaged” and “relaxed” modes of the side bolsters 146 and 148 may be selected by the user by any suitable method (such as a finger-activated switch mounted on an instrument panel or a steering wheel, or a voice-activated switch), or may be selected by the vehicle upon the achievement of particular conditions.

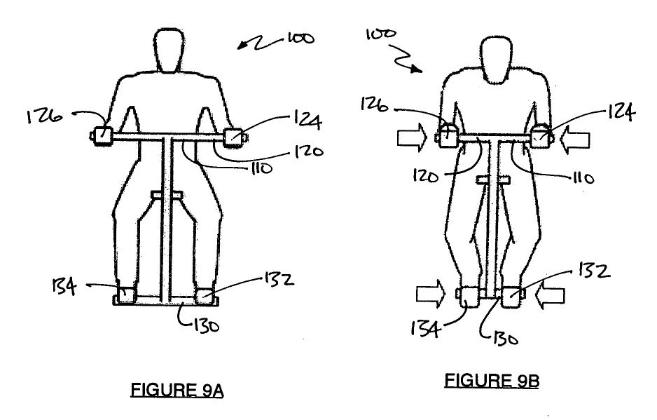

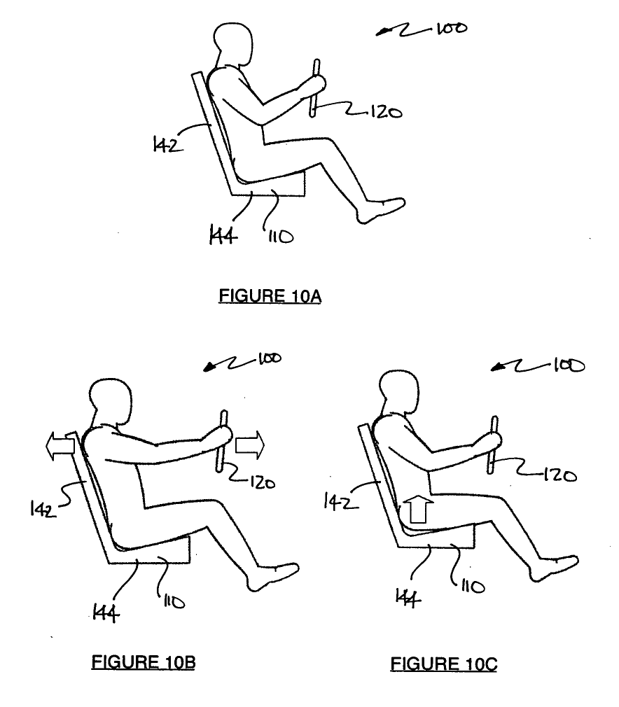

In a third variation, as shown in FIGS. 7-9, the engagement system 110 is very similar to the engagement system 110 of the first variation except that at least a portion of engagement system 110 is movable from a first position to a second position. The movable portion of the engagement system 110 preferably includes two portions that are movable in opposition directions (either linearly or rotationally) from a “near position” to a “far position”, such as the handbase 120 and the footbase 130 that move in linearly opposite directions (FIG. 7) or rotationally opposite directions (FIG. 8), or the left handgrip 124 and the right handgrip 126 of the handbase 120 and/or the left footrest 132 and the right footrest 134 of the footbase 130 (FIG. 9). The movable portions of the engagement system 110 may be moved by the user, or may be moved by an actuator or any other suitable device.

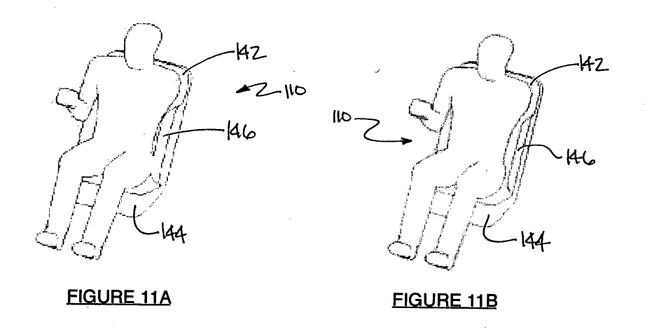

In a fourth variation, as shown in FIG. 10, the engagement system 110 is very similar to the engagement system 110 of the second embodiment except that the engagement system 110 also includes a handbase 120, such as a steering wheel.

### 2. The Sensor System of the Preferred Embodiments

The sensor system of the preferred embodiments functions to sense an intuitive input from the user and to send a sensor output to the processor. In a first variation, as shown in FIGS. 1-3, the sensor system senses the weight distribution of the user. More particularly, the sensor system senses a shift in the weight distribution of the user. The sensor system of this variation may sense a shift in the weight distribution of the user at the handbase 120 and the footbase 130, at the seat 140 and the footbase 130, at the left handgrip 124 and the right handgrip 126, at the left footrest 132 and the right footrest 134, or at any other suitable combination within the engagement system 110. Preferably, the sensor system includes an upper load cell integrated into the handbase 120, a lower load cell integrated into the footbase 130, and a middle load cell integrated into the seat 140. Alternatively, the sensor system may include any other suitable device to sense the weight distribution of the user.

In a second variation, as shown in FIGS. 4-6, the sensor system senses forces imparted by the torso of the user. More particular, the sensor system senses a shift (either in force or in movement) of the torso of the user. The sensor system of this variation may sense a shift of the torso of the user at the left side bolster 146, at the right side bolster 148, at the seat back 142, at the seat bottom 144. Preferably, the sensor system includes force transducers integrated into the left side bolster 146, into the right side bolster 148, into the seat back 142, and into the seat bottom 144. Alternatively, the sensor system may include any other suitable device to sense a shift (either in force or in movement) of the torso of the user.

In a third variation, as shown in FIGS. 7-9, the sensor system senses forces imparted by the appendages of the user. More particularly, the sensor system senses a shift (either in force or in movement) of the appendages of the user. The sensor system of this variation may sense a shift of the appendages of the user at the left handgrip 124 and the right handgrip 126 of the handbase 120, at the left footrest 132 and the right footrest 134 of the footbase 130, or at the handbase 120 and the footbase 130. Preferably, the sensor system includes load cells or force transducers, but may alternatively include any suitable device to sense a shift (either in force or in movement) of the appendages of the user. If the engagement system 110 includes an actuator, the actuator is preferably connected to the sensor system and arranged to move at least a portion of the engagement system 110 from a first position to a second position based on the forces sensed by the sensor system. Thus, the sensor system of this variation may be based on a shift of the forces (and may subsequently command the actuator to move at least a portion of the engagement system 110 between the first position to the second position), or the sensor system may be based on a shift of the position of the engagement system 110 by the user between the first position to the second position.

In a fourth variation, as shown in FIG. 10, the sensor system senses forces imparted by the appendages or the torso of the user. More particularly, the sensor system senses a shift (either in force or in movement) of the appendages or the torso of the user. The sensor system of this variation preferably senses a shift of the appendages at the steering wheel, or senses a shift of the torso at the seat back 142 or at the seat bottom 144. Preferably, the sensor system includes load cells or force transducers, but may alternatively include any suitable device to sense a shift (either in force or in movement) of the appendages or the torso of the user.

### 3. The Processor of the Preferred Embodiments

The processor of the preferred embodiments functions to receive the sensor output from the sensor system, interpret a vehicle command based on the sensor output, and communicate a vehicle command to the vehicle. The processor preferably receives the sensor output via an electrical bus integrated within the vehicle, but may alternatively receive the sensor output via any suitable device or method, such as Bluetooth RF technology. The processor may interpret the vehicle command only when there is significant information to confirm that the user indeed wishes to invoke a particular vehicle command. As an example, the processor may only invoke a vehicle roll command when the user shifts their weight distribution at both the handbase 120 and the footbase 130, and may ignore sensor output when the user only shifts their weight at only one of the handbase 120 and footbase 130. The processor preferably interprets the vehicle command based on the sensor output and other factors, such as vehicle speed, vehicle yaw rate, or any other suitable vehicle parameter. The processor may also interpret the vehicle command based on user preference, whether inputted and stored on a memory device or derived from past experiences. The processor may include a connection to a computer or a network to download new software or to upload user preferences. The processor preferably includes a conventional processor, but may alternatively include any suitable device or method to interpret a vehicle command based on the sensor output.

### 4. The First Preferred Embodiment

In a first preferred embodiment of the invention, as shown in FIGS. 1-3, the interface 100 includes an engagement system 110 of the first variation, a sensor system of the first variation, and a processor that interprets a vehicle command based on the weight distribution of the user. The vehicle is preferably a “ride on” vehicle, such as a two-wheeled bicycle or motorcycle, a four-wheeled all-terrain vehicle (“ATV”), a jet ski, or a snowmobile. The vehicle command is preferably an attitude command (such as a vehicle pitch or a vehicle roll) or a handling command (such as a suspension command or a height command).

The processor may be arranged to interpret a vehicle pitch command based on a shift of the weight distribution of the user at the handbase 120, at the footbase 130, and at the seat 140. As an example, if the user shifts their weight distribution from the seat 140 or footbase 130 (FIG. 1A) to the handbase 120 (FIG. 1B), the processor may interpret the user command as a “pitch forward” command. Similarly, if the user shifts their weight distribution from the handbase 120 (FIG. 1A) to the footbase 130 and/or seat 140 (FIG. 1C), the processor may interpret the user command as a “pitch rearward” command. These commands are fairly intuitive for the user since the user will want to dive down upon the approach of a downward slope, and pull up upon the approach of an upward slope of the terrain.

The processor may be arranged to interpret a vehicle roll command based on a shift of the weight distribution of the user at the right handgrip 126 and the left handgrip 124 of the handbase 120, or at the left footrest 132 and the right footrest 134 of the footbase 130. As an example, if the user shifts their weight distribution from a center position (FIG. 2A) to the right side of the handbase 120 and/or the footbase 130 (FIG. 2B), the processor may interpret the user command as a “roll right” command. Similarly, if the user shifts their weight distribution from a center position (FIG. 2A) to the left side of the handbase 120 and/or the footbase 130 (as shown in FIG. 2C), the processor may interpret the user command as a “roll left” command. Like riding a bicycle or a motorcycle, these commands are fairly intuitive for the user since the user will want to lean into a right turn, and lean into a left turn. This interface 100 allows the user to disconnect the roll command from the steering command, and to invoke a roll command either separate from, or significantly before, a steering command.

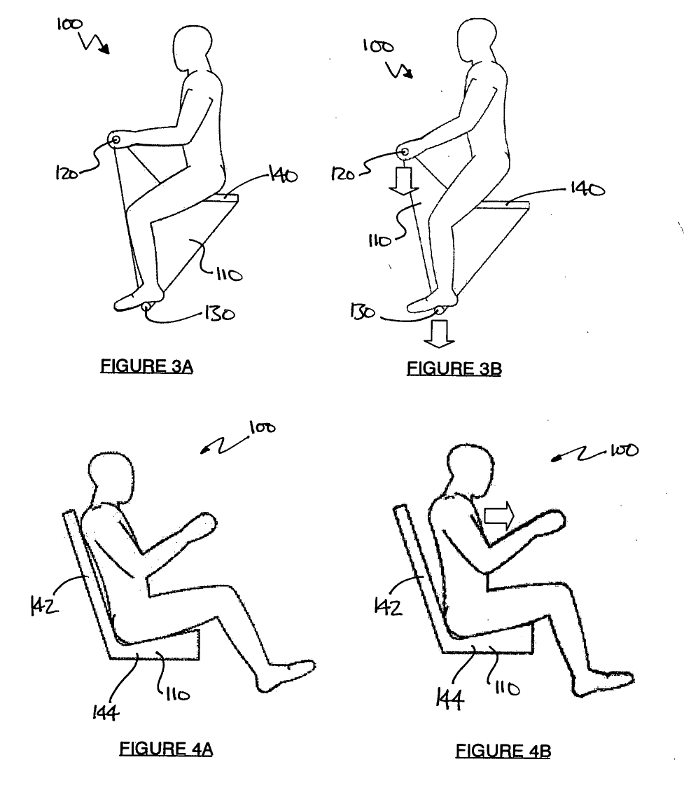

The processor may be arranged to interpret a vehicle height command based on a shift of the weight distribution of the user at the handbase 120, at the footbase 130, and at the seat 140. As an example, if the user shifts their weight distribution from the seat 140 (FIG. 3A) to the handbase 120 and/or footbase 130 (FIG. 3B), the processor may interpret the user command as a “height upward” command and/or a “suspension softer” command. Similarly, if the user shifts their weight distribution from the handbase 120 and/or footbase 130 (FIG. 3B) to the seat 140 (FIG. 3A), the processor may interpret the user command as a “height downward” command and/or a “suspension tighter” command. Like riding a bicycle or a motorcycle, these commands are fairly intuitive for the user since the user will want to stand up and protect their spine during rough terrain (where it is beneficial to ride at a higher height and with a softer suspension), and will want to sit back and secure their grip of the controls during high speeds (where it is beneficial to ride at a lower height and with a tighter suspension).

The processor may, of course, be arranged to interpret any particular combination or permutation of the above vehicle commands.

### 5. The Second Preferred Embodiment

In a second preferred embodiment of the invention, as shown in FIGS. 4-6, the interface 100 includes an engagement system 110 of the second variation, a sensor system of the second variation, and a processor that interprets a vehicle command based on a shift of the torso of the user. The vehicle is preferably a “seated” vehicle, such as a three-wheeled cycle, a four-wheeled automobile or truck, a motorboat, or a small plane or helicopter. The vehicle command is preferably an attitude command (such as a vehicle pitch or a vehicle roll) or a handling command (such as a suspension command or a height command).

The processor may be arranged to interpret a vehicle pitch command based on a shift of the torso of the user at the seat back 142 or at the seat bottom 144. As an example, if the user shifts their torso from a normal position (FIG. 4A) to a forward position (FIG. 4B), the processor may interpret the user command as a “pitch forward” command. Similarly, if the user shifts their torso rearward, the processor may interpret the user command as a “pitch rearward” command. These commands are fairly intuitive for the user since the user will want to dive down upon the approach of a downward slope, and pull up upon the approach of an upward slope of the terrain.

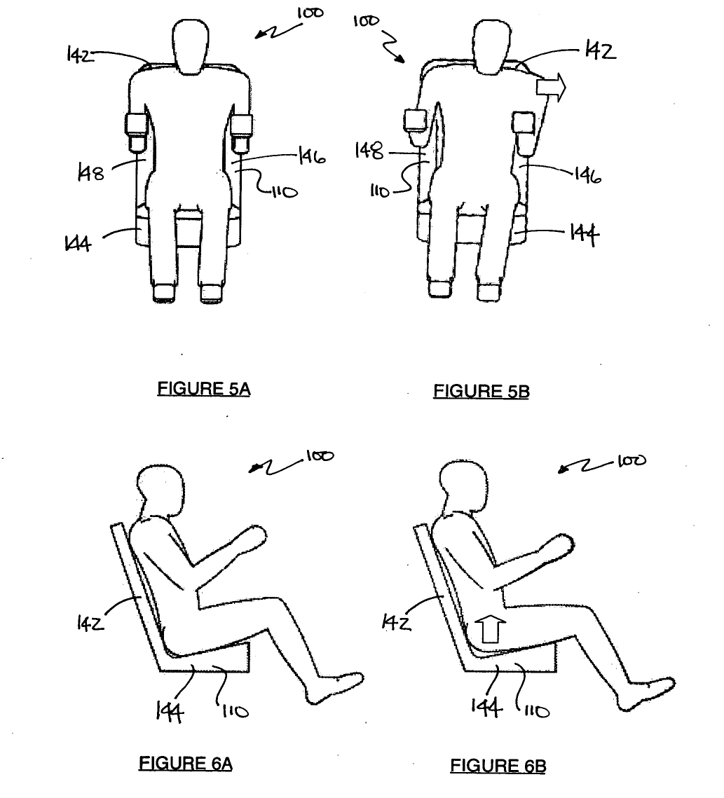

The processor may be arranged to interpret a vehicle roll command based on a shift of the torso of the user at the seat bottom 144 or at the side bolsters 146 and 148. As an example, if the user shifts their torso from a center position (FIG. 5A) to a leaning left position (FIG. 5B), the processor may interpret the user command as a “roll left” command. Similarly, if the user shifts their weight distribution from a center position (FIG. 5A) to a leaning right position (FIG. 5C), the processor may interpret the user command as a “roll right” command. Like taking a hard turn in an automobile, these commands are fairly intuitive for the user since the user will want to lean into a right turn, and lean into a left turn. This interface 100e allows the user to disconnect the roll command from the steering command, and to invoke a roll command either separate from, or significantly before, a steering command.

The processor may be arranged to interpret a vehicle height command based on a shift of the torso of the user at the seat back 142 or at the seat bottom 144. As an example, if the user shifts their torso from a normal position (FIG. 4A) to a forward position (FIG. 4B), the processor may interpret the user command as a “height upward” command. Similarly, if the user shifts their torso rearward, the processor may interpret the user command as a “height downward” command. Like riding in an automobile with a high or tall belt line, these commands are fairly intuitive for the user since the user will want to lean forward and increase their view of the surroundings during rough terrain (where it is beneficial to ride at a higher height), and will want to sit back and secure their grip of the controls during high speeds (where it is beneficial to ride at a lower height).

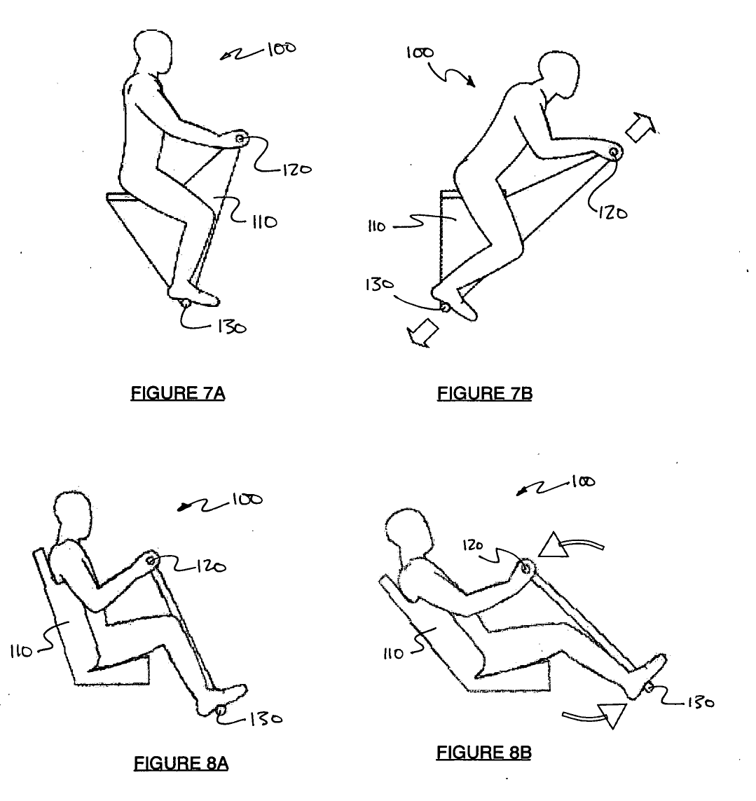

The processor may be arranged to interpret a vehicle suspension command based on a shift of the torso of the user at the seat back 142 or at the seat bottom 144. As an example, if the user shifts their torso from a normal position (FIG. 6A) to a taut position with more weight and force on the thighs and upper back of the user (FIG. 6B), the processor may interpret the user command as a “suspension softer” command. Like riding in an automobile with stiff (or no) shock absorbers, this command is fairly intuitive for the user since the user will want to lift up and protect their spine during rough terrain (where it is beneficial to ride with a softer suspension).

The processor may, of course, be arranged to interpret any particular combination or permutation of the above vehicle commands.

### 6. The Third Preferred Embodiment

In a third preferred embodiment of the invention, as shown in FIGS. 7-9, the interface 100 includes an engagement system 110 of the third variation, a sensor system of the third variation, and a processor that interprets a vehicle command based on a shift of the appendages of the user. The vehicle is preferably a “ride on” vehicle, such as a two-wheeled bicycle or motorcycle, a four-wheeled all-terrain vehicle (“ATV”), a jet ski, or a snowmobile. The vehicle command is preferably a configuration command (such as a wheelbase command, a track command, a hull shape command, or a wing shape command).

The processor may be arranged to interpret a vehicle pitch command based on a shift in opposite directions of the appendages of the user at the handbase 120 and/or at the footbase 130. As an example, if the appendages of the user impart a force that tends to bias the handbase 120 and the footbase 130 in linearly opposite directions (FIG. 7) or rotationally opposite directions (FIG. 8), or that tends to bias the left handgrip 124 and the right handgrip 126 toward each other and/or the left footrest 132 and the right footrest 134 toward each other (FIG. 9), then the processor may interpret the user command as a vehicle “speed mode” command. Similarly, if the appendages of the user impart a force that tends to bias the handbase 120 and the footbase 130 toward each other, tends to bias the left handgrip 124 and the right handgrip 126 in opposition directions, or tends to bias the left footrest 132 and the right footrest 134 in opposition directions, then the processor may interpret the user command as a vehicle “maneuverability mode” command. Like riding a bicycle or a motorcycle, these vehicle commands are fairly intuitive for the user since the user will want to minimize their aerodynamic drag during high speed, and will want to maximize their stability during high maneuverability.

The vehicle, notified with this vehicle configuration command, may take appropriate actions, such as changing the wheelbase (the distance between the front wheels and the rear wheels) or the track (the distance between the left wheels and the right wheels) of a four wheeled automobile, changing the shape of the hull of a motorboat or the wing shape of an aircraft, or deploying stabilizer surfaces or fins on a land vehicle, a watercraft, or an aircraft.

The processor may, of course, be arranged to interpret any particular combination or permutation of the above vehicle commands.

### 7. The Fourth Preferred Embodiment

In a fourth preferred embodiment of the invention, as shown in FIGS. 10A, 10B, and 10C, the interface 100 includes an engagement system 110 of the fourth variation, a sensor system of the fourth variation, and a processor that interprets a vehicle command based on a shift of the appendages or the torso of the user. The vehicle is preferably a “seated” vehicle, such as a three-wheeled cycle, or a four-wheeled automobile or truck. The vehicle command is preferably a mode command (such as a vehicle mode command).

The processor may be arranged to interpret a vehicle “safety alert mode” command based on a shift of the appendages at the steering wheel or a shift of the torso of the user at the seat back 142 or at the seat bottom 144. As an example, if the user forcefully shifts their appendages forward into the steering wheel and/or shifts their torso rearward into the seat back 142 (FIG. 10B) or shifts their torso upward and out from the seat bottom 144 (FIG. 10C), the processor may interpret the user command as a vehicle “safety alert mode” command. This command is fairly intuitive for the user since the user will want to brace themselves in the event of a perceived potential collision of their vehicle. The vehicle, armed with this vehicle “safety alert mode” command, may take defensive actions, such as tightening the suspension, lowering the vehicle, inflating an external and/or internal airbag, or any other suitable action. The vehicle command may be communicated to the vehicle of the user, or may be broadcasted to multiple vehicles. Since the user may be able to sense a potential collision better than an avoidance system of the vehicle, the vehicle “safety alert mode” command may be able to save lives.

The processor may, of course, be arranged to interpret any particular combination or permutation of the above vehicle commands.

Although omitted for conciseness, the preferred embodiments include every combination and permutation of the various engagement systems, the sensor systems, the processors, the vehicles, and the vehicle commands. The preferred embodiments also include every combination of multiple engagement systems, the sensor systems, the processors, the vehicles, and the vehicle commands. As an example, the processor may be arranged to interpret a “bunny hop” command, which may be a combination of a vehicle “pitch forward” command, a vehicle “pitch rearward” command, and a vehicle “height upward” command.

As a person skilled in the art of recognize from the previous detailed description and from the figures and claims, modifications and changes can be made to the preferred embodiments of the invention without departing from the scope of this invention defined in the following claims.

We claim:

1. An interface for communicating a vehicle command from a user to a vehicle, comprising:
an engagement system adapted to engage the torso of a user;
a sensor system coupled to the engagement system and adapted to sense forces imparted by the torso of the user; and
a processor coupled to the sensor system and adapted to interpret a vehicle command based on a shift of the torso of the user and to communicate the vehicle command to a vehicle.

2. The interface of claim 1, wherein the engagement system includes a left side bolster adapted to engage the left portion of the torso of the user, and a right side bolster adapted to engage the right portion of the torso of the user.

3. The interface of claim 2, wherein the sensor system is adapted to sense forces imparted by the torso of the user on the left side bolster and on the right side bolster.

4. The interface of claim 3, wherein the sensor system includes a left force transducer coupled to the left side bolster and a right force transducer coupled to the right side bolster.

5. The interface of claim 3, wherein the processor is further adapted to interpret a vehicle roll command based on a shift of the torso at one of the left side bolster and right side bolster, and to communicate the vehicle roll command to the vehicle.

6. The interface of claim 2, wherein the left side bolster and the right side bolster have an “engaged” position in which the left side bolster and the right side bolster engage the torso of the user and a “relaxed” mode in which the left side bolster and the right side bolster do not engage the torso user.

7. The interface of claim 1, wherein the engagement system includes a seat back.

8. The interface of claim 7, wherein the sensor system is adapted to sense forces imparted by the torso of the user on the seat back.

9. The interface of claim 8, wherein the sensor system includes a load cell coupled to the seat back.

10. The interface of claim 8, wherein the processor is further adapted to interpret a vehicle pitch command based on a shift of the torso on the seat back, and to communicate the vehicle pitch command to the vehicle.

11. The interface of claim 8, wherein the processor is further adapted to interpret a vehicle height command based on a shift of the torso on the seat back, and to communicate the vehicle height command to the vehicle.

12. The interface of claim 8, wherein the processor is further adapted to interpret a vehicle suspension command based on a shift of the torso on the seat back, and to communicate the vehicle suspension command to the vehicle.

13. The interface of claim 1, wherein the engagement system includes a seat bottom.

14. The interface of claim 13, wherein the sensor system is adapted to sense forces imparted by the torso of the user on the seat bottom.

15. The interface of claim 14, wherein the sensor system includes a load cell coupled to the seat bottom.

16. The interface of claim 14, wherein the processor is further adapted to interpret a vehicle roll command based on a shift of the torso on the seat bottom, and to communicate the vehicle roll command to the vehicle.

17. The interface of claim 14, wherein the processor is further adapted to interpret a vehicle height command based on a shift of the torso on the seat bottom, and to communicate the vehicle height command to the vehicle.

18. The interface of claim 14, wherein the processor is further adapted to interpret a vehicle suspension command based on a shift of the torso on the seat bottom, and to communicate the vehicle suspension command to the vehicle.
